(19) United States
(12) Patent Application Publication
(10) Pub. No.: US 2013/0181443 A1
(43) Pub. Date: Jul. 18, 2013

(54) RAPID LEAKAGE-PROOF STRUCTURE FOR TUBES

(71) Applicants: Teng-Hsiang HO, Taichung City (TW); Shih-Yen CHEN, Kaohsiung City (TW)

(72) Inventors: Teng-Hsiang HO, Taichung City (TW); Shih-Yen CHEN, Kaohsiung City (TW)

(21) Appl. No.: 13/668,031

(22) Filed: Nov. 2, 2012

(30) Foreign Application Priority Data
Jan. 18, 2012 (TW) 101101922

(51) Int. Cl. F16L 21/06

(52) U.S. Cl. 285/337

(57) ABSTRACT

A rapid leakage-proof structure for tubes covers an outer surface of a tube and contains an inner soft layer with a first hardness attached to the outer surface of the tube, an outer hard layer with a second hardness covering a surface at one side of the inner soft layer that is far away from the tube, and a clamping assembly. The first hardness is smaller than 60 degrees at Shore Hardness, and the second hardness is greater than the first hardness. The clamping assembly is disposed at one side of the outer hard layer that is far away from the tube to clamp the tube via the outer hard layer and inner soft layer. Thereby, the inner soft layer covers the surface of the tube to obtain high sealing, and the outer hard layer then covers the inner soft layer to prevent leakage caused by insufficient sealing pressure.

### FIELD OF THE INVENTION

The present invention relates to a leakage-proof structure, and more particularly to a rapid leakage-proof structure for tubes.

### BACKGROUND OF THE INVENTION

In daily life, water, electricity, natural gas, and network service are supplied by Water Company, Electric Power Company, and Telecommunications Company respectively. To supply the sources to every family through piping, the piping is arranged under the ground. In order to avoid the piping from breaking, the tubes of the piping have to be made to withstand high pressure and great gravitational loading. But sometime a broken problem of the tubes still happens, thus having a loss.

The broken tube has to be replaced by a new tube or fixed by feeding chemical agents to fill the broken tube, thereby saving replacement time, labor, and cost. Nevertheless, it will take time to dry and solidify the chemical agents, thus wasting waiting time.

Accordingly, an improvement to prevent a leakage problem is to apply a first clamping member and a second clamping member to clamp an outer surface of the tube, and a sealing pad on an outer rim of the first clamping member relative to the second clamping member to achieve a sealing effect. But the sealing position is only located at a connecting position of the sealing pad and the tube, the contact area is small. Besides, the first clamping member and the second clamping member are made of a hard material, thus the sealing effect is limited. In addition, the corrosion on the outer surface of the tube or unevenness caused by other problems easily make the sealing pad cannot tightly connect with the tube, thereby having air leakage or fluid leakage problem.

The present invention has arisen to mitigate and/or obviate the afore-described disadvantages.

### SUMMARY OF THE INVENTION

The primary object of the present invention is to provide a rapid leakage-proof structure for tubes that is capable of overcoming the shortcomings of the conventional leakage-proof structure.

To obtain the above objective, a rapid leakage-proof structure for tubes provided by the present invention covers an outer surface of a tube and contains an inner soft layer with a first hardness, an outer hard layer with a second hardness, and a clamping assembly. The inner soft layer is directly attached to the outer surface of the tube, and the first harness thereof is smaller than 60 degrees at Shore Hardness. The outer hard layer covers the surface at one side of the inner soft layer that is far away from the tube, and the second hardness thereof is greater than the first hardness. The clamping assembly is disposed at one side of the outer hard layer that is far away from the tube to clamp the tube via the outer hard layer and the inner soft layer.

Thereby, the rapid leakage-proof structure of the present invention is capable of covering the tube directly by means of the inner soft layer to avoid a poor sealing effect caused by corrosion of the tube or unevenness caused by welding. In addition, as the outer hard layer covers one side of the inner soft layer that is far away from the tube, thus a secure structure is obtained and the leakage problem caused by insufficient sealing pressure of the clamping assembly also is prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a rapid leakage-proof structure for tubes according to a first embodiment of the present invention.

FIG. 2 is an exploded view of the rapid leakage-proof structure for the tubes according to the first embodiment of the present invention.

FIG. 3 is a sectional view of the rapid leakage-proof structure for the tubes according to the first embodiment of the present invention.

FIG. 4 is a sectional view of a rapid leakage-proof structure for tubes according to a second embodiment of the present invention.

FIG. 5 is a sectional view of a rapid leakage-proof structure for tubes according to a third embodiment of the present invention.

### DETAILED DESCRIPTION OF THE PREFERRED EMBODIMENTS

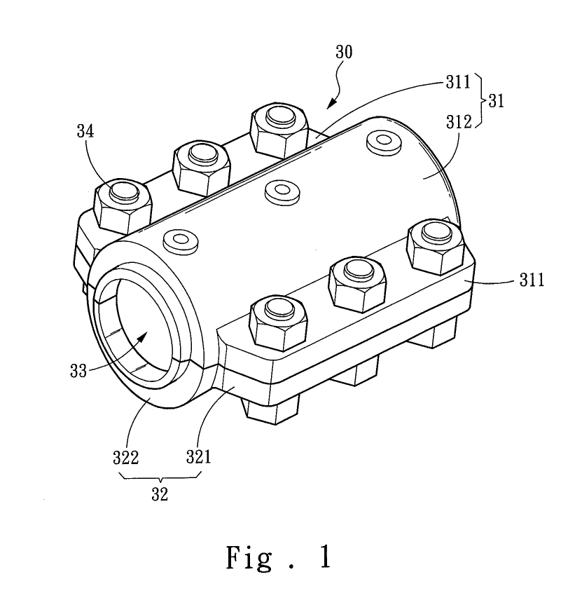

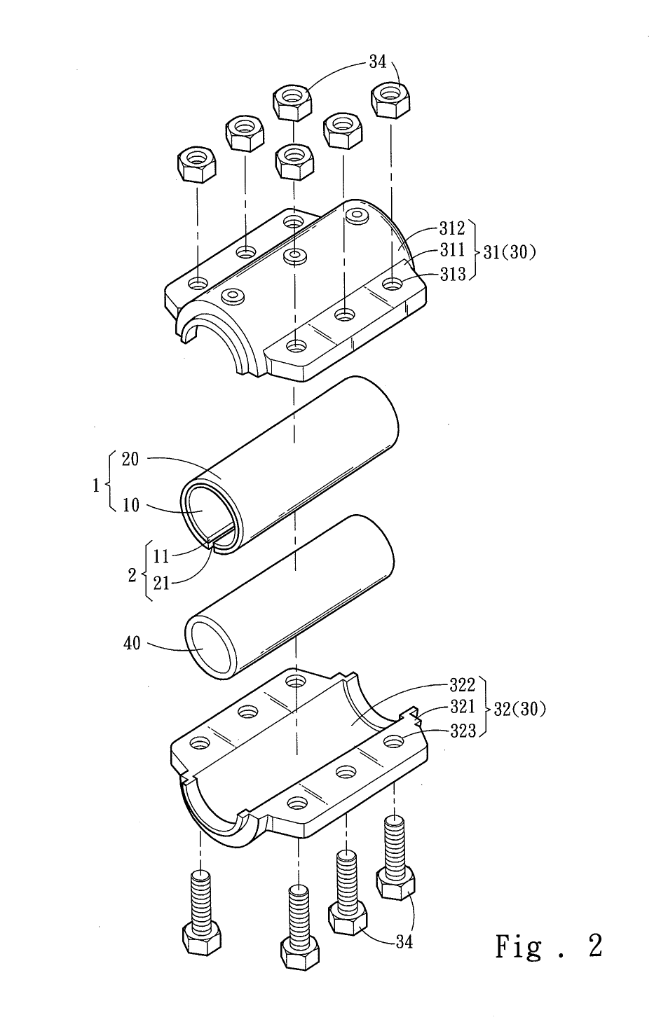

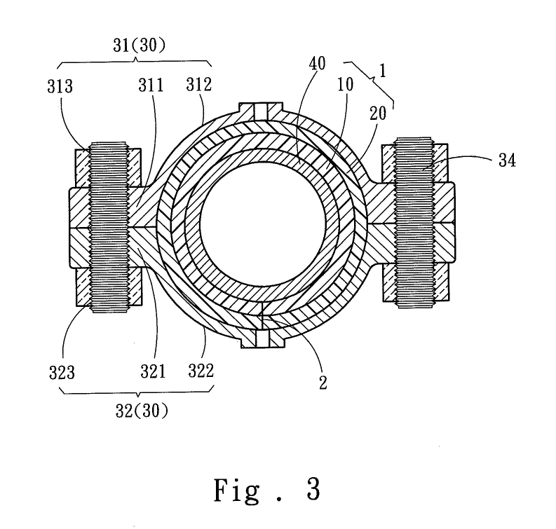

With reference to FIGS. 1-3, a rapid leakage-proof structure for tubes according to a first embodiment of the present invention covers an outer surface of a tube 40 and comprises an inner soft layer 10 with a first hardness, an outer hard layer 20 with a second hardness, and a clamping assembly 30. The inner soft layer 10 is directly attached to the outer surface of the tube 40, and the first hardness is smaller than 60 degrees at Shore Hardness (HS). The outer hard layer 20 covers a surface at one side of the inner soft layer 10 that is far away from the tube 40, and the second hardness is greater than the first hardness. The clamping assembly 30 is disposed at one side of the outer hard layer 20 that is far away from the tube 40 to clamp the tube 40 via the outer hard layer 20 and the inner soft layer 10.

The inner soft layer 10 and the outer hard layer 20 are made of an elastic rubber material with anti-acid/base property and formed in a tubular structure. The inner soft layer 10 and the outer hard layer 20 have respectively an inner assembling slot 11 and an outer assembling slot 21 that are formed axially and parallel to the tube 40. In this embodiment, the inner soft layer 10 and the outer hard layer 20 are integrally connected through secondary processing, so that the inner assembling slot 11 and the outer assembling slot 21 are respectively located at a first position of the inner soft layer 10 and a second position of the outer hard layer 20 that are corresponding to each other. Thereby, the inner soft layer 10 and the outer hard layer 20 can cover the tube 40 inside through expanding the inner assembling slot 11 and the outer assembling slot 21. Of course, the inner soft layer 10 and the outer hard layer 20 are designed as two separated components and two sides thereof are connected together to cover the tube 40.

The clamping assembly 30 contains a first clamping member 31 and a second clamping member 32 relative to first clamping member 31. The first clamping member 31 has two first connecting walls 311 corresponding to each other and a first arcuate covering wall 312 defined between the two first connecting walls 311, and the second clamping member 32 has two second connecting walls 321 corresponding to each other and a second arcuate covering wall 322 defined between the two second connecting walls 321. The two first connecting walls 311 are coupled with the two second connecting walls 321 so that the first arcuate covering wall 312 and the second arcuate covering wall 322 are connected to form a holding chamber 33 for covering the outer hard layer 20, the inner soft layer 10, and the tube 40. Furthermore, the first clamping member 31 has at least one first coupling hole 313 on each of the two first connecting walls 311, and the second clamping member 32 has at least one second coupling hole 323 on each of the two second connecting walls 321 corresponding to the at least one first coupling hole 313. The at least one first coupling hole 313 and the at least one second coupling hole 323 are fastened through at least one fastening element 34 to securely hold the first clamping member 31 and the second clamping member 32 together.

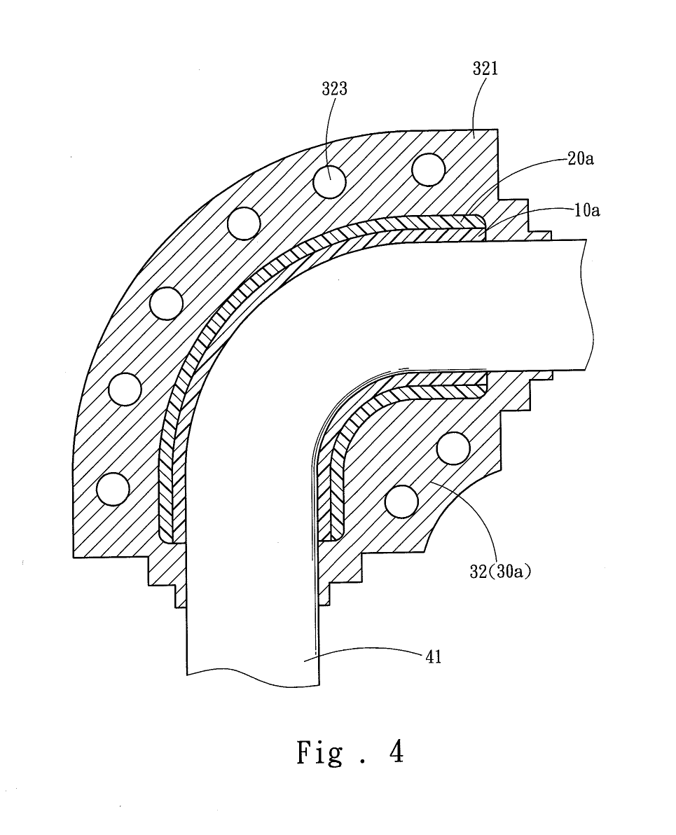

Referring further to FIG. 4, a rapid leakage-proof structure for tubes according to a second embodiment of the present invention also can be used in a curved tube 41, wherein the rapid leakage-proof structure comprises an outer hard layer 20a and an inner soft layer 10a to incorporate with a clamping assembly 30a to cover the curved tube 41. The outer hard layer 20a and the inner soft layer 10a may have assembling slots to hold and cover the curved tube 41. Since the curved tube 41 is easy to be broken, the rapid leakage-proof structure of the present invention can stop leaking upon the leakage occurs and further prevent the leakage before the leakage occurs by covering the curved tube 41, thus a sealing effect is obtained.

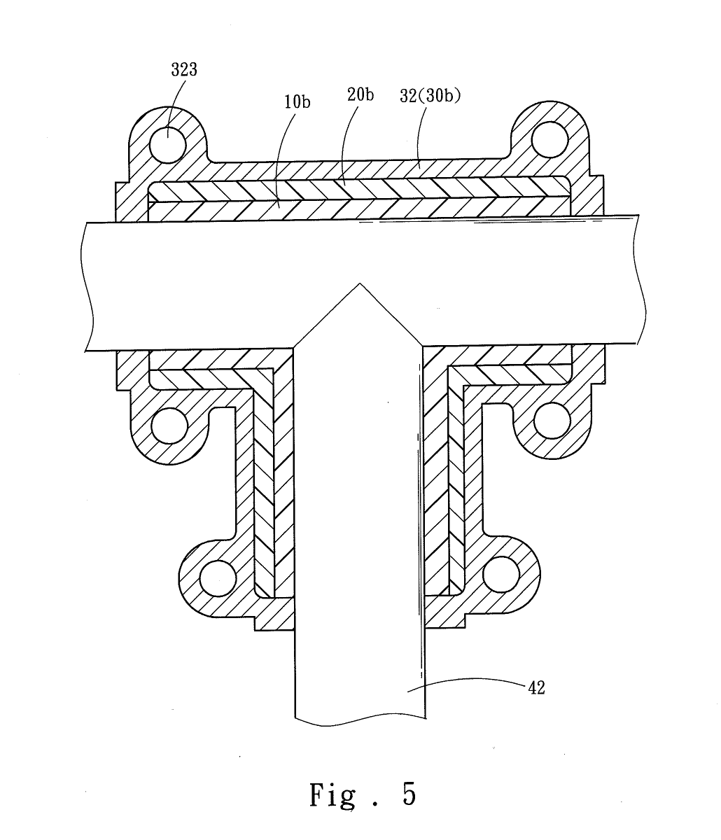

As shown in FIG. 5, a rapid leakage-proof structure for tubes according to a third embodiment of the present invention is applied to a T-shaped tube 42 and comprises an inner soft layer 10b, an outer hard layer 20b, and a clamping assembly 30b. Because the T-shaped tube 42 has at least one welded section, its structural strength is weaker than that of the straight tube 40 or the curved tube 40. Through the inner soft layer 10b, the outer hard layer 20b, and the clamping assembly 30b, the invention can achieve leak-proof and sealing effect.

Thereby, the rapid leakage-proof structure of the present invention is capable of covering the tube directly by means of the inner soft layer to avoid a poor sealing effect caused by corrosion of the tube or unevenness caused by welding. In addition, as the outer hard layer covers one side of the inner soft layer that is far away from the tube, thus a secure structure is obtained and the leakage problem caused by insufficient sealing pressure of the clamping assembly also is prevented. Moreover, through expanding the inner assembling slot and the outer assembling slot, the rapid leakage-proof structure of the invention can cover the outer surface of the tube conveniently.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A rapid leakage-proof structure for tubes covering an outer surface of a tube, and comprising:
an inner soft layer with a first hardness attached to the outer surface of the tube, and the first hardness being smaller than 60 degrees at Shore Hardness;
an outer hard layer with a second hardness covering a surface at one side of the inner soft layer that is far away from the tube, and the second hardness being greater than the first hardness;
a clamping assembly disposed at one side of the outer hard layer that is far away from the tube to clamp the tube via the outer hard layer and the inner soft layer.

2. The rapid leakage-proof structure for the tubes as claimed in claim 1, wherein the inner soft layer and the outer hard layer are elastic and formed in a tubular structure, the inner soft layer and the outer hard layer including respectively an inner assembling slot and an outer assembling slot that are formed axially and parallel to the tube.

3. The rapid leakage-proof structure for the tubes as claimed in claim 2, wherein the inner assembling slot and the outer assembling slot are respectively located at a first position of the inner soft layer and a second position of the outer hard layer that are corresponding to each other.

4. The rapid leakage-proof structure for the tubes as claimed in claim 1, wherein the clamping assembly comprises:
a first clamping member including two first connecting walls corresponding to each other and a first arcuate covering wall defined between the two first connecting walls;
a second clamping member that is relative to the first clamping member and includes two second connecting walls corresponding to each other and a second arcuate covering wall defined between the two second connecting walls; and
wherein the two first connecting walls are coupled with the two second connecting walls so that the first arcuate covering wall and the second arcuate covering wall are connected to form a holding chamber for covering the outer hard layer, the inner soft layer, and the tube.

5. The rapid leakage-proof structure for the tubes as claimed in claim 4, wherein the first clamping member includes at least one first coupling hole on each of the two first connecting walls, and the second clamping member includes at least one second coupling hole on each of the two second connecting walls corresponding to the at least one first coupling hole, the at least one first coupling hole and the at least one second coupling hole are fastened through at least one fastening element to securely hold the first clamping member and the second clamping member together.
